(19) United States
(12) Patent Application Publication
(10) Pub. No.: US 2002/0188585 A1
(43) Pub. Date: Dec. 12, 2002

(54) Data transfer utilizing hidden windows

(76) Inventors: Murthy Atmakuri, Sunnyvale, CA (US); Alexandra Nsonwu, San Jose, CA (US); Hanchang Kuo, Fremont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/794,603

(22) Filed: Feb. 27, 2001

(51) Int. Cl. G06F 7/00

(52) U.S. Cl. 707/1

(57) ABSTRACT

An apparatus, article of manufacture, and method for displaying data on a computer network. One embodiment of the method, for example, comprises displaying via a browser a first document from the computer network; requesting a second document for display; receiving data for the second document for display; determining that the second document cannot yet be displayed; and storing the data for the second document.

### BACKGROUND

This invention relates generally to use of data retrieved from a computer network. More specifically, various embodiments of this invention relate to the storage of data retrieved from a computer network.

Computer networks operate by transmitting data from server computers to client computers. The client computer will often request information from a server in order to implement an application program. As a result, high network traffic results from the many different client computers making requests on the network.

Thus, with every request made on a network there is a typical waiting period in which the requestor must wait for the requested information to arrive from the server. When many client computers and many server computers exist on a network, the result is a high amount of traffic and consequently longer waiting periods.

In addition, when a browser is utilized by a computer to access a document stored on a server computer, the request typically is not made until the browser is ready to utilize the data. Thus, the browser waits to request the data until it knows that it can utilize the data that is received. As a result, there is a delay in obtaining the needed data from the server as the browser must wait for the data to be received before displaying the data.

### SUMMARY

One embodiment of the invention provides a method of displaying data from a computer network. The method comprises displaying via a browser a first document from the computer network; requesting a second document for display; receiving data for the second document for display; determining that the second document cannot yet be displayed; and storing the data for the second document.

Yet another embodiment of the invention provides a method of displaying data from a computer network that comprises opening a first window for displaying a first set of data; displaying the first set of data in the first window; opening a second window for use in storing a second set of data; obtaining the second set of data from the computer network; and storing the second set of data in the second window.

Other embodiments of the invention allow data retrieved from the computer network to be comprised alternatively of javascript objects, HTML data, cookies, etc.

Furthermore, some embodiments of the invention allow a user to indicate a command for a first set of data, while data stored in an undisplayed window is utilized.

Further features of the invention will be apparent to those of ordinary skill in the art from a consideration of the folowing description taken in conjunction with the accompanying drawings, wherein certain methods, apparatuses and articles of manufacture for practicing the embodiments of the invention are illustrated. However, it is to be understood that the invention is not limited to the details disclosed but includes all such variations and modifications as fall within the spirit of the invention and the scope of the issued appended claims.

### BRIEF DESCRIPTION OF THE DRAWINGS

FIG. 1 is a flowchart for an embodiment of the invention illustrating how data can be stored in a second document when a first document is displayed.

FIG. 2 is a flowchart for an embodiment of the invention illustrating how data for a second document can be stored in a window while a first document is displayed in a first window.

FIG. 3 is a flowchart for an embodiment of the invention illustrating the use of an HTTP request to obtain data for a document.

FIGS. 4a and 4b illustrate a flowchart for an embodiment of the invention in which data stored in a second window can be utilized for processing while data for a first document is displayed.

FIG. 5 illustrates a network configuration for one embodiment of the invention which includes a content receiver such as a set-top box.

FIG. 6 illustrates an embodiment of the invention in which an email interface indicates that it is currently configured for use by the user “ALEXANDRA” while 6 new messages are shown as available for the user “KIM.”

FIG. 7 illustrates an embodiment of the invention in which commands for “ALEXANDRA'S” email box can be entered.

FIG. 8 illustrates an embodiment of the invention in which a Personal Identification Number (PIN) can be entered by the user “KIM.”

FIG. 9 illustrates an embodiment of the invention in which commands for “KIM'S” email box can be entered.

FIGS. 10a and 10b illustrate a flowchart for implementing an email system which utilizes an embodiment of the invention.

### DESCRIPTION

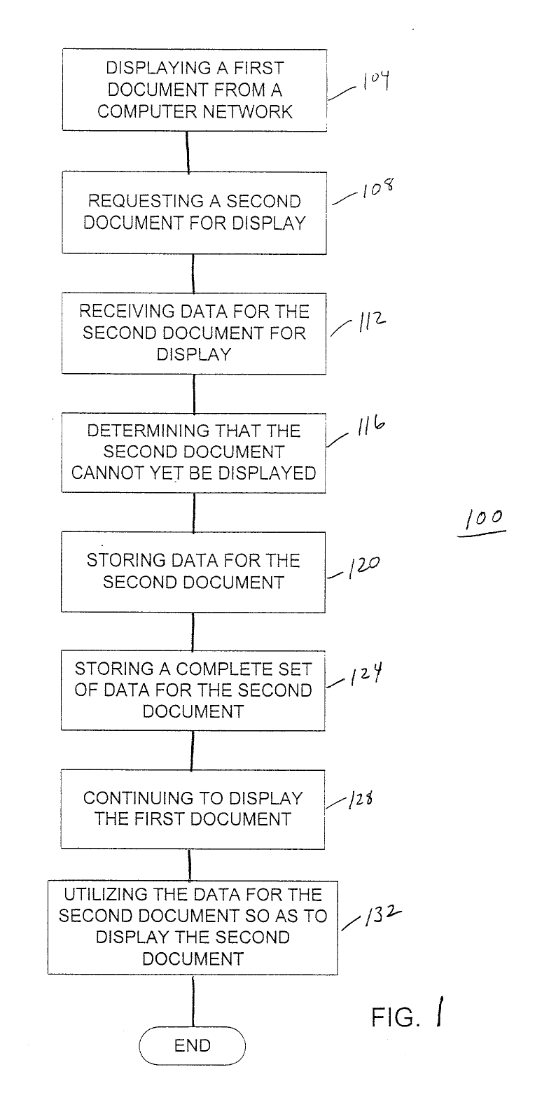

Referring now to the drawings and more particularly to FIG. 1, an embodiment of the invention can be described. In FIG. 1, a flowchart 100 describes the operation of a first embodiment of the invention. This flowchart describes how a program that displays a first document can store a second document for later display by the browser.

Namely, in method 100 of FIG. 1, block 104 indicates that a first document from a computer network is displayed. For example, in negotiating the Internet, a browser such as Netscape Navigator™ or Microsoft Explorer™ is often used to obtain a document from the Internet for display on a computer that uses the browser. In the context of this patent, the word document is intended to mean a set of data that is requested from an address on a network, e.g., a set of HTML data retrieved from a website. In block 108, a second document is requested. In this embodiment, the second document is a document that is intended to replace the first document on the browser of the user, for example. One way of requesting such a document is through the use of HTTP commands, as one of ordinary skill in the art would readily understand. Such commands allow users to access documents stored on other computers that are coupled to a computer network, such as the Internet. Upon receiving a request for data—an HTTP request, for example—the computer network can route the request to the appropriate address on the computer network, for example a server coupled to the computer network. This server can then invoke an application program that retrieves the requested document from a database, for example. The server can then transmit the requested document to the computer that submitted the request. The data could take different forms. For example, the data for the document might be in the form of HTML data. Similarly, it might take the form of JavaScript objects. As yet another example, it might take the form of a cookie. It is also envisioned that other types of data as would be readily understood by those of ordinary skill in the art could be conveyed. Furthermore, other types of formats for conveying documents will surely be developed in the future. They should be understood to fall under the scope of this patent, as well. In block 112, the data for the second document is received. For example, the browser receives the data transmitted by the server across the computer network.

In block 116, a determination is made as to whether the second document can be displayed, for example by the browser. If it is determined that the second document cannot be displayed, the second document is cached for later display. This determination can be made before, during or after a portion of the data for the second document is actually retrieved. Under normal conditions, one would display a requested document immediately upon its receipt at the requesting computer. However, in some instances that will not be possible or might not be desirable.

For example, when a user submits a request for a document, such as a listing of a user's emails, it is desirable to confirm that the user is actually entitled to view the emails. This entitlement can be determined through an authorization confirmation process, for example by checking a password that a user enters. While the confirmation process takes place, the emails can be requested from the email server on the network. Thus, the emails can be stored for use once the user's entitlement to view the emails is confirmed. This is but one example of how data for a second document can be stored prior to display.

Thus, when it is determined that the document cannot be displayed, the data received for the second document is stored in memory accessible by the computer, e.g., accessible by the computer's browser, as noted in block 120 of FIG. 1. Consequently, a complete document can be stored once the complete set of data for the second document is received, as noted in block 124.

Until a determination is made that the second document is to be displayed, the computer continues to display the first document. This is indicated by block 128 in FIG. 1. Ultimately, when the determination is made that the second document can be displayed, the data for the second document is accessed from storage and utilized to display the second document, as indicated in block 132 of FIG. 1. The process can then be repeated for successive documents.

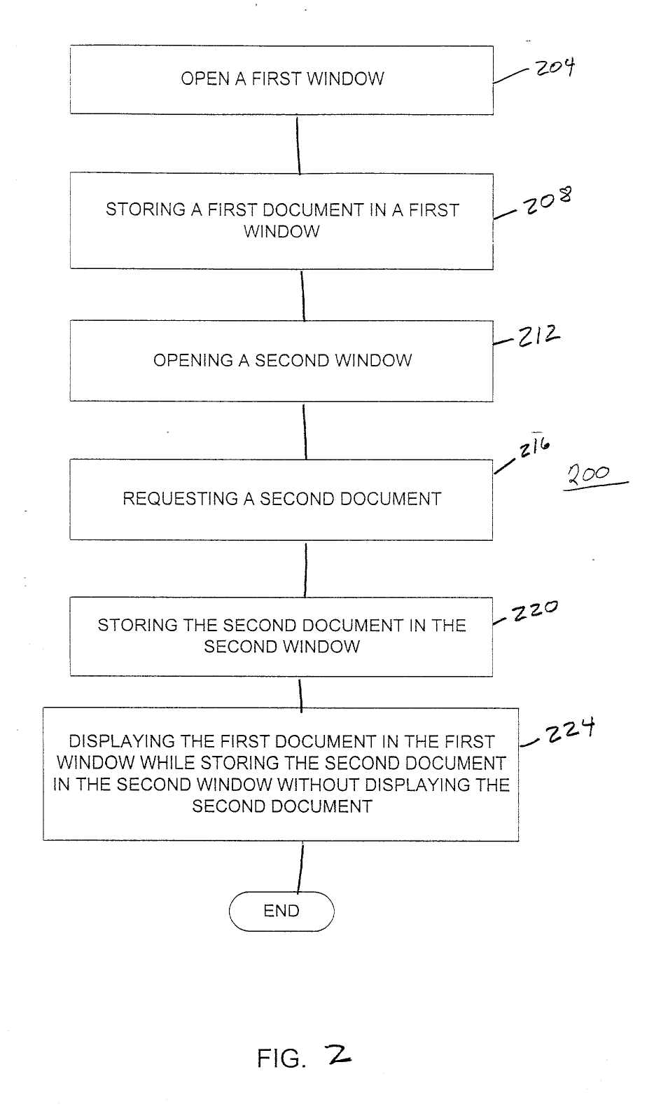

One embodiment of the invention allows for the storage of the data for the second document (or succeeding documents) in a window accessible by the computer that displays the first document. This is illustrated in method 200 of FIG. 2. In block 204 of FIG. 2, a first window is opened, for example by an application program or directly by a user. In this window, a first document is displayed or stored, as illustrated in block 208. A second window can also be opened, as shown by block 212. A second document is then requested (block 216) and stored in the second window as shown by block 220. At this stage, the first document can continue to be displayed while the second document is stored in the second window (block 224). Eventually, the second document can be displayed or as is the case with another embodiment of the invention, manipulated by an application program but not displayed.

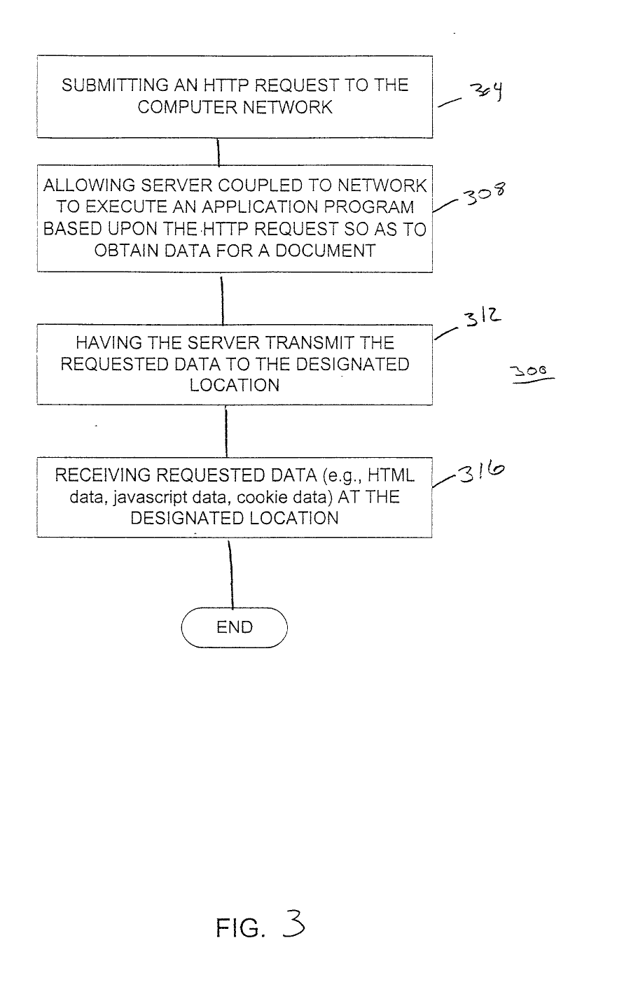

FIG. 3 illustrates an embodiment of the invention for retrieving data from the computer network. In block 304 of FIG. 3, flowchart 300 shows that a computer can submit an HTTP request to the computer network. A server coupled to the computer network is then allowed to execute an application program, for example, so as to obtain the requested data required by the HTTP request, as referenced in block 308. The server then transmits the requested data to the designated location in block 312. And, the requested data is received (block 316) at the designated location, e.g., at the second window which is accessible by the browser. Block 316 also shows that the requested data can take different forms. As examples, the data could be HTML data, JavaScript data, cookie data.

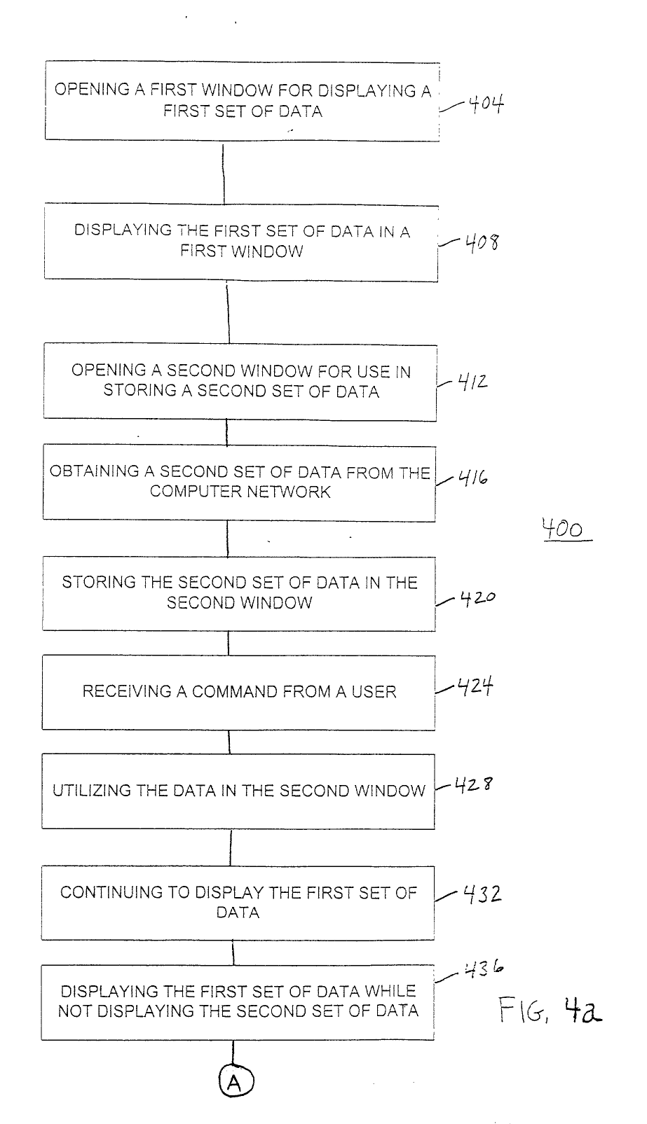

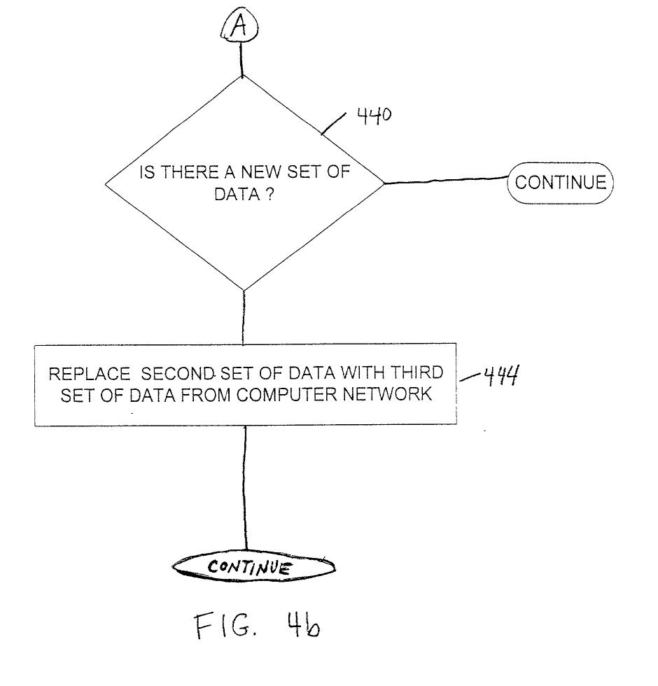

FIGS. 4a and 4b illustrate yet another embodiment of the invention as illustrated by flowchart 400. This embodiment of the invention illustrates how data can be stored in a second window without the need to display the data. Yet, the data can still be utilized, for example, to reduce repeated requests to a server for the stored information.

In block 404, a first window for displaying a set of data is opened. Then, the first set of data is displayed in the first window 408. A second window is opened in block 412 which can be used to store a second set of data or second document. Then, the second set of data can be obtained from a computer network, as illustrated by block 416. For example, this might take place through an HTTP command. The second set of data is stored in the second window, as illustrated by block 420. However, it is not necessary that it be displayed. In some instances, the second set of data may be desired merely for use by the computer as opposed to display by the computer.

At this stage, the computer can request or receive commands from a user as shown in block 424. Depending on the command received from the user, an application program could be invoked that requires the data stored in the second window. Thus, as merely one example, the application program could utilize the data stored in the second window as illustrated by block 428.

If the data in the second window is not intended for display, the document in the first window will continue to be displayed as noted by block 432. Thus, the first set of data is displayed while the second set of data is not displayed 436. To accomplish this, the second window is formatted as a hidden window.

The process can be repeated in order to download another document that can be utilized. Thus, in block 440, a determination is made as to whether a new set of data or document is required. If it is, then, for example, the process can be repeated by replacing the second set of data with a cache of a third set of data, as shown in block 444. Alternatively, a third window could be opened to store the third set of data. In fact, it is envisioned that as many windows as necessary for storing sets of data could be opened.

This invention thus allows the application program to have the data available in the second window. As one potential impact, this can reduce traffic on the computer network. Plus, it allows the data to be available locally as opposed to requiring the client computer to repeatedly request the data from the server across a network.

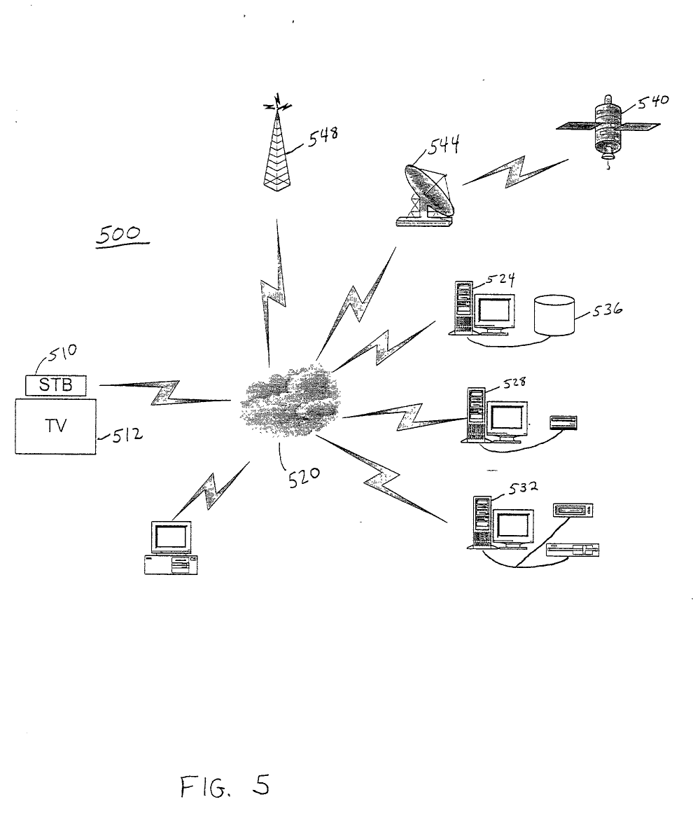

Another embodiment of the invention can be illustrated by the following example applied to an email system. In FIG. 5 a network system 500 is shown. The network system shown in FIG. 5 is comprised of a plurality of servers (524, 528, and 532) coupled to a variety of data storage devices, such as database 536. The servers are coupled to a computer network 520, such as the Internet. In addition, other data transmission devices are connected to the computer network, such as satellite 540 and receiver 544. Similarly, an RF transmitter 548 is also shown as coupled to the computer network. Also, a content receiver 510 for receiving program content is shown coupled to the computer network. A set-top box would qualify as such a content receiver. The set-top box 510 in FIG. 5 is shown coupled to a television 512. In addition, a client computer 514 capable of addressing the server computers is shown coupled to the computer network.

The set-top box in this example is comprised of software that allows a group of users, for example a family, to access their individual private email accounts via the computer network. Each email account is accessible via the computer network.

The set-top box supports a multi-user environment. Thus, each user has his/her own profile—e.g., preferences, privileges, setup—saved in the database 536 on the remote server. This profile is then accessed to validate or implement a user's request at the set-top box. As a result, there is high network traffic and increased response time.

As explained above, one embodiment allows a “hidden” or second window to be opened by the browser to store data. In the present email example, a user's information is stored in the hidden window rather than accessed over the network.

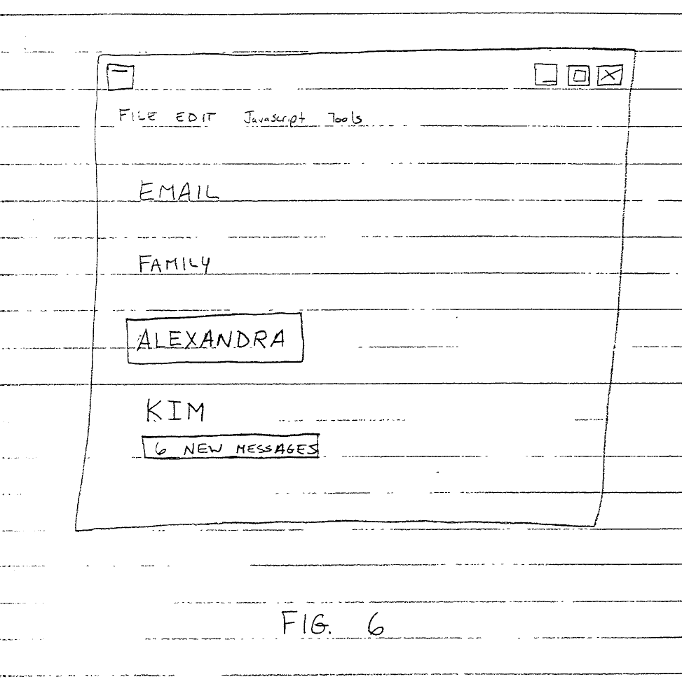

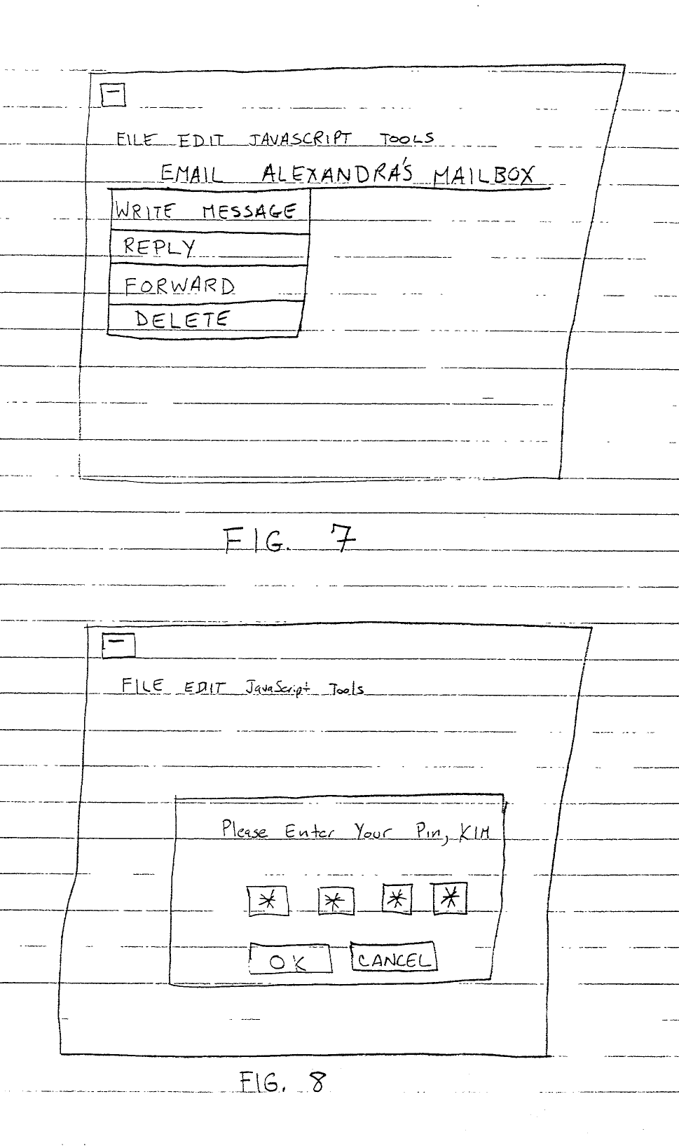

In the email example, there are three users: Family, Kim and Alexandra. In FIG. 6, the open window shows via highlighting that the current user is Alexandra. Thus, the hidden window has been loaded from the server with information related to Alexandra's profile. Selecting Alexandra's email box brings up her email account options on the set-top box, as shown in FIG. 7.

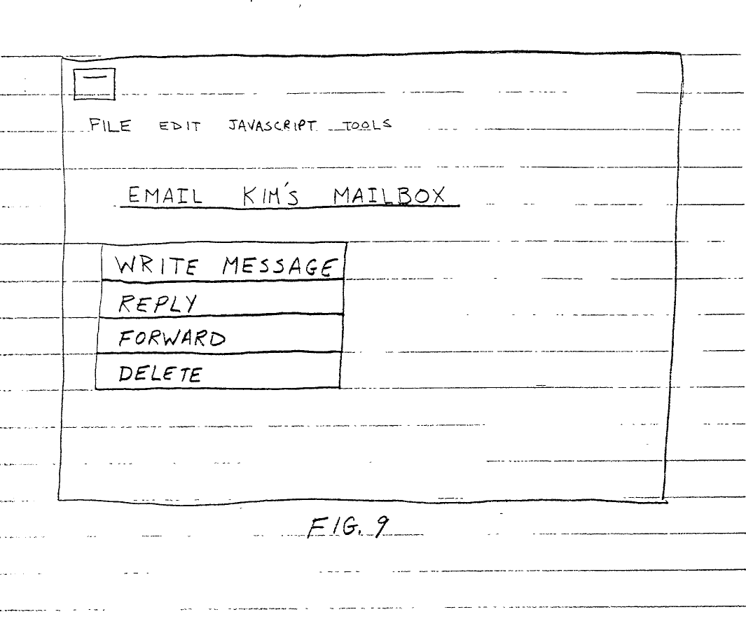

When the user “Kim” wants to view her email account from the multi-user set-top box environment, she selects her name from the screen in FIG. 6. Before the set-top box provides her email account to her, however, her authority to access the email account must be verified. This is shown in FIG. 8. While her password could be checked by accessing the server through the computer network, this embodiment of the invention allows her password to be checked locally by using code, e.g., Javascript functions, defined in the hidden window. Thus, the hidden window can store profile information about Alexandra as well as Javascript functions that serve to authorize a transition to a new user. This allows the main window to be displayed without interruption without requiring accessing the server across the computer network.

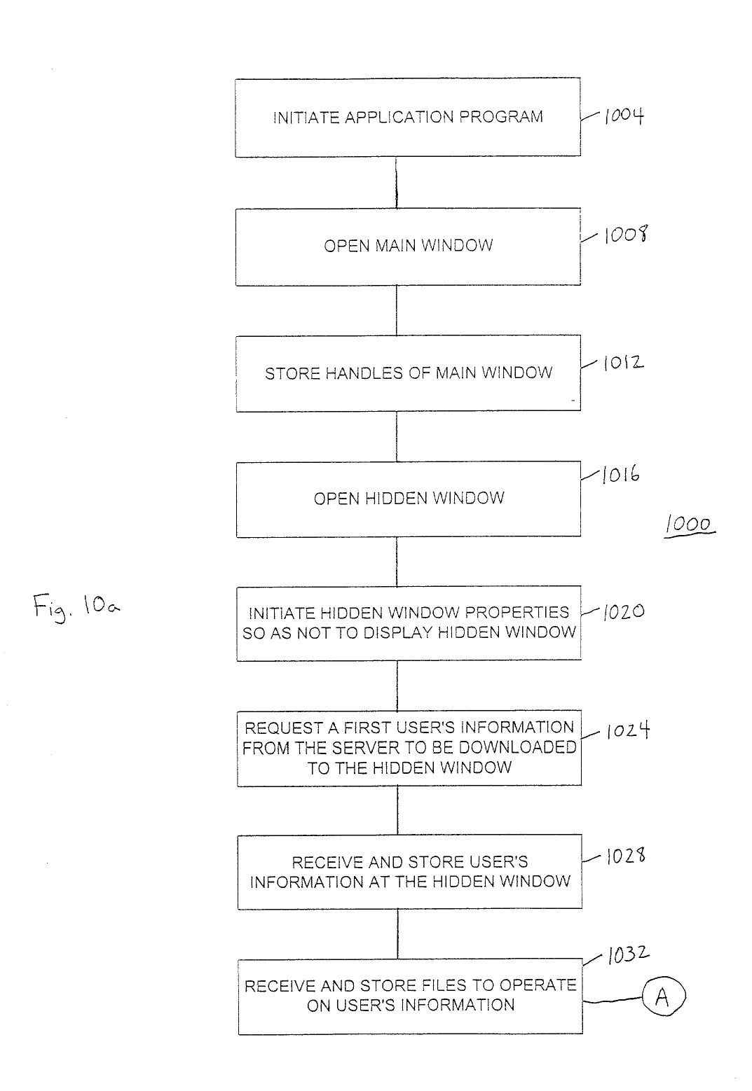

Once Kim's identity is verified, the current user account changes to Kim from Alexandra. So, it is then appropriate to update the hidden window with Kim's profile information. These changes can take place transparent to the user such that the user interface is not necessarily affected until the transaction is complete, at which time Kim's email box is shown, as illustrated in FIG. 9. Similarly, the “Family's” user account could be accessed as well.

One way to implement this embodiment is through the use of HTML and Javascript code. An application program can launch a first routine, e.g. in javascript code, to open the primary window which is shown in FIGS. 6, 7, 8, and 9. A variable is assigned to hold the handle of this window. Then, the second (or “hidden”) window is opened. This window is assumed to be a background window with no content to display. Furthermore, the window size is made zero. This can be accomplished for example with the following command:

wo.gUsers=registerWin(“/global/gusers_empty.htm”, 0, 0, 0, 0, 4);

The hidden window is then initialized for example with the following HTML page:

<BODY background=″images/h_bkgd.gif″text=#ffffff onload=″home_Init( )″onunload=″home_CleanUp ( ) “onkeyout=”return home_HandleKeyDown( )″>

The initialization can then be verified, for example, via a “TestCookie” function to confirm that the hidden window is correctly initialized:

if(!TestCookie( ))
{
setTimeout(“home_InitUsers( )”,5000;
}

The function “home₁₃ InitUsers” sets the location of the hidden window to a servlet on the server, for example “com.sony.dma.users.users” as follows:

function home_InitUsers( )
{
wndUsers = window.opener.winInfo[window.opener.gUsers];
wndUsers.location.href = “/servlet/com.sony.dma.users.users”;
}

In response, the servlet “com.sony.dma.users.users” sends back the users information in HTML/Javascript formats to the hidden window. Thus, in this fashion the user information for Kim or Alexandra or family can be conveyed from the server to the hidden window for easy access.

In addition to the function which initializes the hidden window with the profile information about the user, additional functions can be used to verify the password of a new user, change the user interface, get the current user ID, and get an email ID. For example the function “ChangeUser( )” can be used to change the current user (Alexandra) to the new one (Kim). Thus, this function causes a page to be re-loaded with new user settings (sent by servlet com.sony.dma.users.users) after the new user's credentials are verified. While this function is executed, the calling application (e.g., the HTML page) can wait for a short time period to allow for the delay in obtaining the new user settings to be retrieved from the server.

```
function ChangeUser(strUser, strPwd)
{
debugtext(“ChangeUser to: “+strUser);
if(VerifyPassword(strUser, strPwd))
{
  var temp =
“/servlet/com.sony.dma.users.users?CHANGE_USER=”+escape(strUser);
  navigator[“cache”].remove(temp);
window.location.href=temp;
}
else debugtext(“VerifyPassword()failed”);
}
```

An example of a user related function can be performed by the function “pin_init( )” function. The function pin_init( ) retrieves the window handle for the hidden window to be used by other functions:

function pin_Init()
{
wo=window.opener.top.window.opener;
m_wndUser=wo.winInfo[wo.gUsers];
pin_WriteUserName();
}
The onload event handler invokes the “pin_init()” function:
<BODY

bgcolor=“transparent”background=“/images/
pin/d_bkgd_t.gif' text=“white”

onvisible=“Javascript:pin_HandlePinVisible()”
onload=“pin_Init()”
onkeyout=“return mpin_HandleKeyDown()”>

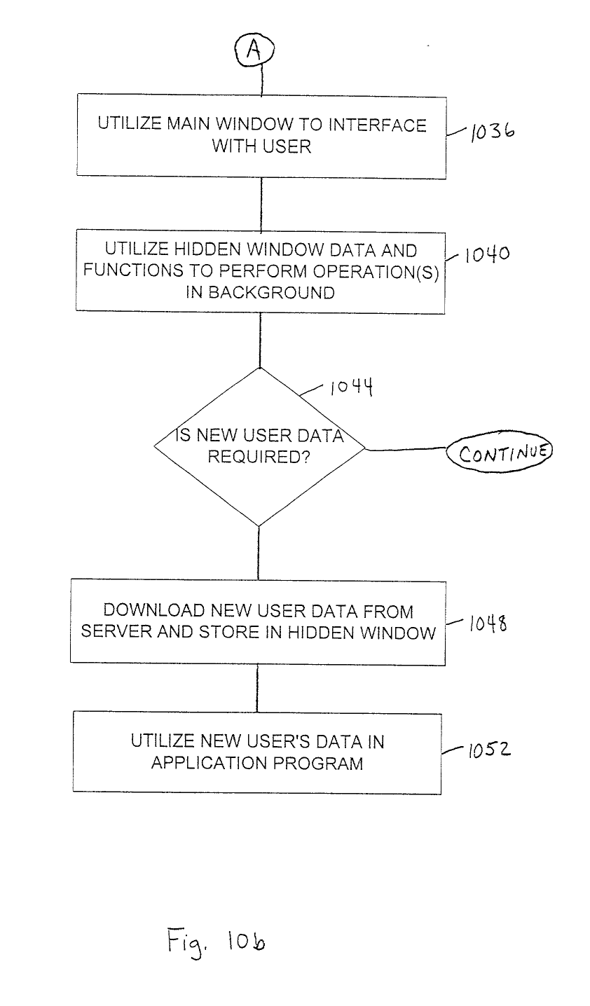

The email example can also be illustrated by the flowhart 1000 shown in FIGS. 10a and 10b. In block 1004 of FIG. 10a, an application program on the content receiver is initiated. The application program causes a main window to be opened in block 1008. The main window in this example is utilized to interface with the user. Then, the handles for the main window are stored, as illustrated by block 1012. In block 1016, the hidden window is opened. The properties of the hidden window are initiated so as not to display the hidden window (block 1020).

A request for a first user's information can be made to download from the server for storage in the hidden window, as shown in block 1024. In response, the user's information is received and stored at the hidden window, as illustrated in block 1028. In addition to the the user's information, files to operate on the user's information, e.g., in the form of javascript format, can be stored in the hidden window (block 1032).

In FIG. 10b, the main window is utilized to interface with the user, as shown by block 1036. Upon receipt of a command through the main window, the hidden window data and functional code can be utilized to perform operations in the background, block 1040.

Thus, in the email example, if new user data is required by the determination in block 1044, the new user data can be downloaded from the server and stored in the hidden window (block 1048). Then, this new user's data can be utilized by the application program or code stored in the hidden window (block 1052). If no new user data is required, the application program continues its operation.

While various embodiments of the invention have been described as methods or apparatus for implementing the invention. It should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that the embodiments expressed above also be considered protected by this patent in their program code means as well.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures and acts recited herein can be recited as means for performing a function or steps for performing a function, respectively. Therefore, it should be understood that such language is entitled to cover all such structures or acts disclosed within this specification and their equivalents, including the matter incorporated by reference.

It is thought that the apparatuses and methods of the embodiments of the present invention and many of its attendant advantages will be understood from this specification and it will be apparent that various changes may be made in the form, construction and arrangement of the parts thereof without departing from the spirit and scope of the invention or sacrificing all of its material advantages, the form herein before described being merely exemplary embodiments thereof.

What is claimed is:

1. A method of utilizing data from a computer network, said method comprising:
opening a first window for displaying a first set of data;
displaying said first set of data in said first window;
opening a second window for use in storing a second set of data;
obtaining said second set of data from said computer network;
storing said second set of data in said second window.

2. The method of utilizing data from a computer network as described in claim 1 and further comprising:
setting the location of the second window to a servlet on a server of the computer network.

3. The method of utilizing data from a computer network as described in claim 1 wherein said obtaining said second set of data from said computer network comprises:
receiving said second set of data in HTML format.

4. The method of utilizing data from a computer network as described in claim 1 and further comprising:
receiving said second set of data in javascript format.

5. The method of utilizing data from a computer network as described in claim 1 and further comprising:
receiving a command from a user;
utilizing said data in said second window; and then continuing to display said first set of data.

6. The method of utilizing data from a computer network as described in claim 1 and further comprising:
displaying said first set of data while not displaying said second set of data.

7. The method of utilizing data from a computer network as described in claim 1 and further comprising:
obtaining a third set of data from said computer network.

8. The method of utilizing data from a computer network as described in claim 7 and further comprising:
replacing said second set of data with said third set of data.

9. A computer program product for use with a computer, said computer program product comprising:
a computer usable medium comprising computer readable program code embodied in said medium for causing a display of data from a computer network, said computer program product comprising:
computer readable program code for causing said computer to open a first window for displaying a first set of data;
computer readable program code for causing said computer to display said first set of data in said first window;
computer readable program code for causing said computer to open a second window for use in storing a second set of data;
computer readable program code for causing said computer to obtain said second set of data from said computer network;
computer readable program code for causing said computer to store said second set of data in said second window.

10. The computer program product as described in claim 9 and further comprising:
computer readable program code for causing said computer to set the location of the second window to a servlet on a server of the computer network.

11. The computer program product as described in claim 9 wherein said computer readable program code for causing said computer to obtain said second set of data from said computer network comprises:
computer readable program code for causing said computer to receive said second set of data in HTML format.

12. The computer program product as described in claim 9 and further comprising:
computer readable program code for causing said computer to receive said second set of data in javascript format.

13. The computer program product as described in claim 9 and further comprising:
computer readable program code for causing said computer to receive a command from a user;
computer readable program code for causing said computer to utilize said data in said second window in response to said command and continue to display said first set of data.

14. The computer program product as described in claim 9 wherein said computer readable program code for causing said computer to utilize data from a computer network comprises:
computer readable program code for causing said computer to display said first set of data while not displaying said second set of data.

15. The computer program product as described in claim 9 and further comprising:
computer readable program code for causing said computer to obtain a third set of data from said computer network.

16. The computer program product as described in claim 15 and further comprising:
computer readable program code for causing said computer to replace said second set of data with said third set of data.

17. A method of cacheing HTML data, said method comprising:
displaying a first view of a web browser;
allowing a user to input a request for a network address;
submitting an HTTP request to a computer network so as to obtain data for a second view on said web browser;
allowing a server to execute an application based upon said HTTP request so as to obtain said data for said second view on said web browser;
receiving a response from said server as HTML data for said second view on said web browser;
determining that said first view displayed on said web browser may not be replaced with said second view on said web browser;
cacheing the HTML data;
determining that the first view on said web browser may be replaced with the second view on said web browser; and
utilizing the cached HTML data to display said second view on said web browser.

18. A method of displaying data from a computer network, said method comprising:
displaying via a browser a first document from said computer network;
requesting a second document for display;
receiving data for said second document for display;
determining that said second document cannot yet be displayed; and
storing said data for said second document.

19. The method of displaying data from a computer network as described in claim 18 and further comprising:
utilizing said data for said second document so as to display said second document.

20. The method of displaying data from a computer network as described in claim 18 and further comprising:
continuing to display said first document while storing said data for said second document.

21. The method of displaying data from a computer network as described in claim 18 and further comprising:
storing a complete set of data for said second document so as to allow said complete set of data to be utilized to display said second document.

22. The method of displaying data from a computer network as described in claim 18 wherein said requesting a second document for display comprises:
submitting an HTTP request to said computer network.

23. The method of displaying data from a computer network as described in claim 22 and further comprising:
allowing a server coupled to said computer network to execute an application based upon said HTTP request so as to obtain said data for said second document.

24. The method of displaying data from a computer network as described in claim 18 wherein said receiving data for said second document for display comprises:
receiving HTML data from a server coupled to said computer network.

25. The method of displaying data from a computer network as described in claim 18 and further comprising:
receiving javascript data from said server coupled to said computer network.

26. The method of displaying data from a computer network as described in claim 18 and further comprising:
receiving a cookie from said server coupled to said computer network.

27. The method of displaying data from a computer network as described in claim 18 and further comprising:
storing said first document in a first window accessible by said browser;
storing said second document in a second window accessible by said browser.

28. A computer program product for use with a computer, said computer program product comprising:
a computer usable medium comprising computer readable program code embodied in said medium for causing a display of data from a computer network, said computer program product comprising:
computer readable program code for causing said computer to display via a browser a first document from said computer network;
computer readable program code for causing said computer to request a second document for display;
computer readable program code for causing said computer to receive data for said second document for display;
computer readable program code for causing said computer to determine that said second document cannot yet be displayed; and
computer readable program code for causing said computer to store said data for said second document.

29. The computer program product as described in claim 28 and further comprising:
computer readable program code for causing said computer to utilize said data for said second document so as to display said second document.

30. The computer program product as described in claim 28 and further comprising:
computer readable program code for causing said computer to continue to display said first document while storing said data for said second document.

31. The computer program product as described in claim 28 and further comprising:
computer readable program code for causing said computer to store a complete set of data for said second document so as to allow said complete set of data to be utilized to display said second document.

32. The computer program product as described in claim 28 wherein said computer readable program code for causing said computer to request a second document for display comprises:
computer readable program code for causing said computer to submit an HTTP request to said computer network.

33. The computer program product as described in claim 32 and further comprising:
computer readable program code for causing said computer to allow a server coupled to said computer network to execute an application based upon said HTTP request so as to obtain said data for said second document.

34. The computer program product as described in claim 28 wherein said computer readable program code for causing said computer to receive data for said second document for display comprises:
computer readable program code for causing said computer to receive HTML data from a server coupled to said computer network.

35. The computer program product as described in claim 28 and further comprising:
computer readable program code for causing said computer to receive javascript data from said server coupled to said computer network.

36. The computer program product as described in claim 28 and further comprising:
computer readable program code for causing said computer to receive a cookie from said server coupled to said computer network.

37. The computer program product as described in claim 28 and further comprising:
computer readable program code for causing said computer to store said first document in a first window accessible by said browser;
computer readable program code for causing said computer to store said second document in a second window accessible by said browser.

38. A computer data signal embodied in an electromagnetic signal, said computer data signal comprising:
an HTML formatting segment; and
an address segment identifying a hidden window.

39. The computer data signal as described in claim 38 and further comprising:
a data segment comprising data for storage in said hidden window.

40. A computer data signal embodied in an electromagnetic signal, said computer data signal comprising:
a javascript formatting segment; and
an address segment identifying a hidden window.

41. The computer data signal as described in claim 40 and further comprising:
a data segment comprising data for storage in said hidden window.
